(19) United States
(12) Patent Application Publication
(10) Pub. No.: US 2026/0025566 A1
(43) Pub. Date: Jan. 22, 2026

(54) IMAGE PROCESSING DEVICE, IMAGING APPARATUS, AND OPERATION METHOD OF IMAGE PROCESSING DEVICE

(71) Applicant: FUJIFILM Corporation, Tokyo (JP)

(72) Inventors: Kazuki ISHIDA, Saitama (JP); Shinichi FUJIMOTO, Saitama (JP); Toshiki KOBAYASHI, Saitama (JP); Koichi TANAKA, Saitama (JP)

(73) Assignee: FUJIFILM Corporation, Tokyo (JP)

(21) Appl. No.: 19/340,420

(22) Filed: Sep. 25, 2025

Related U.S. Application Data
(63) Continuation of application No. PCT/JP2024/011588, filed on Mar. 25, 2024.

(30) Foreign Application Priority Data
Mar. 29, 2023 (JP) 2023-054374

(51) Int. Cl. H04N 23/61; G06V 40/20; H04N 23/698

(52) U.S. Cl. CPC H04N 23/61; G06V 40/20; H04N 23/698

(57) ABSTRACT

One embodiment according to the disclosed technology provides an image processing device, an imaging apparatus, and an operation method of an image processing device for performing image processing on a moving image. An image processing device according to an aspect includes a processor, in which the processor is configured to acquire a first moving image, specify a first subject included in the first moving image, detect a first factor caused by an action of the first subject in the first moving image, specify a region including a second subject in the first moving image based on the first factor, and perform image processing on at least the region including the second subject. The processor may be configured to generate a second moving image that is a moving image including the second subject. The processor may be configured to detect the second subject after detecting the first factor.

### CROSS-REFERENCE TO RELATED APPLICATIONS

The present application is a Continuation of PCT International Application No. PCT/JP2024/011588 filed on Mar. 25, 2024 claiming priority under 35 U.S.C §119(a) to Japanese Patent Application No. 2023-054374 filed on Mar. 29, 2023. Each of the above applications is hereby expressly incorporated by reference, in its entirety, into the present application.

### BACKGROUND OF THE INVENTION

### 1. Field of the Invention

The present invention relates to an image processing device, an imaging apparatus, and an operation method of an image processing device for processing a moving image.

### 2. Description of the Related Art

As a technology for processing a moving image, for example, JP2016-158241A discloses an imaging apparatus that presents composition by taking a motion of a subject or a target of interest during capturing of a moving image into consideration.

### SUMMARY OF THE INVENTION

One embodiment according to the disclosed technology provides an image processing device, an imaging apparatus, and an operation method of an image processing device for processing a moving image.

An image processing device according to a first aspect of the present invention comprises a processor, in which the processor is configured to acquire a first moving image, specify a first subject included in the first moving image, detect a first factor caused by an action of the first subject in the first moving image, specify a region including a second subject in the first moving image based on the first factor, and perform image processing on at least the region including the second subject.

According to a second aspect of the present invention, in the image processing device according to the first aspect, the processor is configured to generate a second moving image through the image processing.

According to a third aspect, in the image processing device according to the first or second aspect, the processor is configured to detect the second subject after detecting the first factor.

According to a fourth aspect, in the image processing device according to any one of the first to third aspects, the processor is configured to detect one or more of a determined action of the first subject, information related to a direction of the first subject, and utterance of a determined vocalization of the first subject as the first factor.

According to a fifth aspect, in the image processing device according to any one of the first to fourth aspects, the processor is configured to perform at least one of trimming or image quality adjustment as the image processing.

According to a sixth aspect, in the image processing device according to any one of the first to fifth aspects, the processor is configured to trim at least a range including the second subject from the first moving image.

According to a seventh aspect, in the image processing device according to the sixth aspect, the processor is configured to trim a range including the first subject and the second subject from the first moving image.

According to an eighth aspect, in the image processing device according to any one of the first to seventh aspects, the processor is configured to generate a third moving image by trimming a range including the first subject from the first moving image, generate a fourth moving image by trimming a range including the second subject from the first moving image, and associate the third moving image and the fourth moving image with each other.

According to a ninth aspect, in the image processing device according to the eighth aspect, the processor is configured to generate a fifth moving image that is one moving image, based on the third moving image and the fourth moving image.

According to a tenth aspect, in the image processing device according to any one of the first to ninth aspects, the processor is configured to adjust the first moving image for at least one of resolution, noise, color tone, brightness, contrast, contours, or a special effect.

According to an eleventh aspect, in the image processing device according to any one of the first to tenth aspects, the processor is configured to perform the image processing for a period from detection of the first factor to satisfaction of a predetermined condition.

According to a twelfth aspect, in the image processing device according to the eleventh aspect, the processor is configured to, in a case where a determined time elapses from the detection of the first factor, and/or a second factor caused by an action of the first subject or the second subject is detected, determine that the predetermined condition is satisfied.

According to a thirteenth aspect, in the image processing device according to the second aspect, the processor is configured to extract a frame of the second moving image as a still image. In the image processing device according to the aspects of the present invention, frames of the above first, third, fourth, and fifth moving images may be extracted as still images.

An imaging apparatus according to a fourteenth aspect comprises the image processing device according to any one of the first to thirteenth aspects, and an imaging system that captures the first moving image, in which the processor is configured to perform the image processing on the first moving image captured by the imaging system.

According to a fifteenth aspect, in the imaging apparatus according to the fourteenth aspect, the processor is configured to receive designation of a subject in the first moving image and control the imaging system to continuously image at least the designated subject.

According to a sixteenth aspect, in the imaging apparatus according to the fourteenth or fifteenth aspect, the imaging system is an omnidirectional imaging system.

Examples of the aspect of the present invention also include an imaging method executed by an imaging apparatus including the image processing device according to any one of the first to thirteenth aspects, and an imaging system that captures a first moving image, the imaging method comprising, via the processor, performing image processing on a first moving image captured by the imaging system. In the imaging method, the processor may be configured to receive designation of a subject in the first moving image and control the imaging system to continuously image at least the designated subject. The imaging methods may be imaging methods executed by an imaging apparatus that captures a first moving image via an omnidirectional imaging system. Examples of the aspect of the present invention also include an imaging program causing a computer to execute the imaging methods, and a non-transitory tangible recording medium on which a computer-readable code of such an imaging program is recorded.

According to a seventeenth aspect of the present disclosure, an operation method of an image processing device including a processor comprises, via the processor, acquiring a first moving image, specifying a first subject included in the first moving image, detecting a first factor caused by an action of the first subject in the first moving image, specifying a region including a second subject in the first moving image based on the first factor, and performing image processing on at least the region including the second subject. The operation method according to the seventeenth aspect may have the same configuration as the second to thirteenth aspects. Examples of the aspect of the present invention also include an image processing program causing a computer to execute the operation method of the aspects, and a non-transitory tangible recording medium on which a computer-readable code of such an image processing program is recorded.

### BRIEF DESCRIPTION OF THE DRAWINGS

FIG. 1 is a diagram illustrating a configuration of an image processing device according to a first embodiment.

FIG. 2 is a flowchart illustrating a processing procedure of an image processing method.

FIG. 3 is a diagram illustrating a state where a first subject is specified in a frame of a first moving image.

FIG. 4 is a diagram illustrating a state where a first factor is detected.

FIG. 5 is a diagram illustrating a state where a second subject is detected with reference to a database.

FIG. 6 is a diagram illustrating a state where the second subject is detected from the frame of the first moving image.

FIG. 7 is a diagram illustrating an example of trimming.

FIGS. 8A and 8B are diagrams illustrating a state of processing after the trimming performed for the first time.

FIGS. 9A to 9C are diagrams illustrating a state of processing based on a second factor caused by the second subject.

FIGS. 10A to 10C are diagrams illustrating an example of disposition of regions in a fifth moving image.

FIG. 11 is a diagram illustrating a configuration of an imaging apparatus in a second embodiment.

FIG. 12 is a diagram illustrating a configuration of an imaging unit in the second embodiment.

### DESCRIPTION OF THE PREFERRED EMBODIMENTS

### [Image Processing in Editing Moving Image]

Automatic optimization (suggestion) of an image quality parameter or trimming of a still image has been widely performed. However, applying this technology to individual frames constituting a moving image may lose a “narrative” and an “impression” to be expressed by the moving image. For example, in a case where “trimming that achieves a predetermined ratio of an area of a subject to the whole image” is applied to each frame of the moving image, a ratio of the subject and a background is always constant, and a complex intention of a motion picture creator such as “impressing a motion picture viewer with where the subject is by showing the background in an enlarged manner at a certain location or a certain time” or “showing a facial expression of the subject as large as possible at a certain time so that unnecessary objects are not included” cannot be expressed. Meanwhile, it is very difficult for a user to manually perform these operations. While the trimming is described here, the same problem may arise even in the case of adjusting the image quality parameter.

The following problems may arise in the captured moving image depending on a condition such as an angle of view of a camera (for example, in the case of a wide angle lens, a fisheye lens, or a 360-degree camera).

(1) The captured moving image may not have the optimal image quality for a region to be finally cut out. For example, in a case where imaging is performed to achieve the optimal image quality of the whole visual field, an image trimmed from the captured image may be an image with a vague impression (a so-called “dull” image) because of a lack of clarity.

(2) A processor or a computer cannot recognize where the subject is present in the captured image.

(3) Even in a case where the subject is designated, the processor or the computer cannot determine which range of the captured image is to be cut out.

The inventors of the present application have conducted intensive studies in view of such circumstances, and have conceived the invention of the present application. Hereinafter, specific aspects of the invention of the present application (an image processing device, an imaging apparatus, and an operation method of an image processing device) will be described with reference to the accompanying drawings.

### First Embodiment

### [Configuration of Image Processing Device]

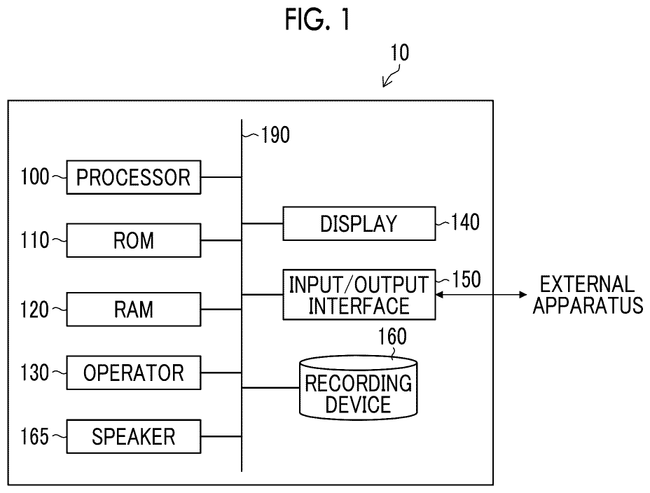

FIG. 1 is a diagram illustrating a configuration of an image processing device according to a first embodiment. As illustrated in FIG. 1, an image processing device 10 (the image processing device) comprises a processor 100 (a processor), a read only memory (ROM) 110, a random access memory (RAM) 120, an operator 130, a display 140 (a display device or an output device), an input/output interface 150, a recording device 160 (a recording device or an output device), and a speaker 165, and these constituents are connected to each other through a bus 190 and communicate with each other, as necessary.

For example, the processor 100 is composed of various processors or electric circuits such as a central processing unit (CPU), a graphics processing unit (GPU), a field programmable gate array (FPGA), and a programmable logic device (PLD). In executing software (a program) via the processors or electric circuits, a code of the executed software readable by a computer (for example, various processors or electric circuits constituting the processor and/or a combination thereof) is stored in a non-transitory tangible recording medium such as the ROM 110, and the computer refers to the software.

The software stored in the non-transitory tangible recording medium may include an image processing program according to an embodiment of the present invention (a program causing the computer to execute the operation method of the image processing device (the image processing method) according to the embodiment of the present invention), an imaging program (a program causing the computer to execute an imaging method), and data used for executing the image processing program and the imaging program. The code may be recorded on a non-transitory tangible recording medium such as a flash ROM or an electronically erasable and programmable read only memory (EEPROM) instead of the ROM 110. The “non-transitory tangible recording medium” does not include a non-tangible recording medium such as a carrier wave signal or a propagation signal. In processing using the software, the RAM 120 is used as a temporary storage region or a work region.

Processing using the processor 100 having the above configuration will be described in detail later.

The operator 130 is composed of devices such as a keyboard and a mouse (not illustrated). The user can provide an instruction to the image processing device 10 through these devices, and the processor 100 receives the instruction and performs processing corresponding to the received instruction. The display 140 may be composed of a touch panel device so that the user can provide the instruction through the touch panel. The display 140 is composed of a touch panel device, a liquid crystal display device, or the like and can display an acquired moving image, a moving image generated through image processing, a screen for condition setting, and the like.

The input/output interface 150 is composed of a terminal or a slot for connecting an external apparatus such as a display, a printer, or a recording medium, a communication interface for Wi-Fi (registered trademark) or Bluetooth (registered trademark), and the like. The image processing device 10 can acquire moving image data from the external apparatus (a server apparatus, a recording device, a database, an imaging apparatus, or the like) through the input/output interface 150 or acquire information indicating a “relationship between a first factor caused by an action of a first subject and a second subject” (described later) by accessing an external database. The external apparatus may be connected to the image processing device 10 in a wired manner or a wireless manner. The external apparatus may be connected through a network such as the Internet.

The recording device 160 is composed of a recording medium (a non-transitory tangible recording medium) such as a hard disk, a semiconductor memory, or various magneto-optical recording media, and a control unit thereof, and can record a moving image (a first moving image) before performing editing or the image processing, a moving image (second to fifth moving images) after performing the editing or the image processing, the above information indicating the “relationship between the first factor caused by the action of the first subject and the second subject”, and the like. A vocalization included in the moving image can be output from the speaker 165.

For example, the above image processing device 10 can be implemented by installing the software (the program) for acquiring the image and performing the image processing on an apparatus such as a personal computer, a smartphone, or a tablet terminal.

### [Processing of Image Processing Method]

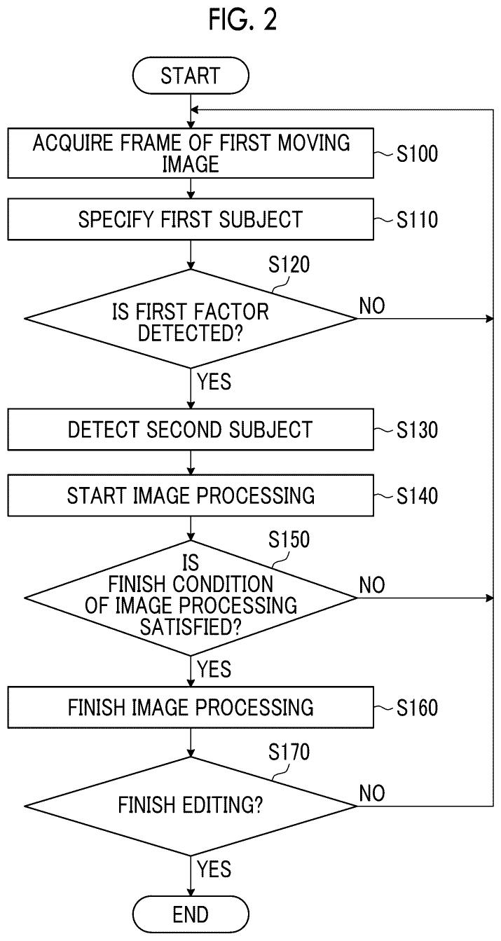

The image processing method (the operation method of the image processing device) in the image processing device 10 having the above configuration will be described. FIG. 2 is a flowchart illustrating a processing procedure of the image processing method.

### [Acquisition of Moving Image]

The processor 100 (the processor) acquires a frame of the moving image (the first moving image) (step S100). The processor 100 may collectively acquire data of the already captured moving image (for example, collectively acquire the whole file) and then process individual frames, or may perform capturing and acquisition of the moving image and the image processing in parallel. The processor 100 may perform acquisition of the moving image and the image processing in real time (without a time delay). The processor 100 can acquire the moving image from the imaging apparatus, the recording medium, the recording device, or the recording device 160 connected through the input/output interface 150. In a case where the imaging apparatus is connected to the image processing device 10, the processor 100 may control (zoom, focus, pan, and/or tilt) the imaging apparatus to capture the moving image (the first moving image) and acquire the captured moving image. In this case, the processor may receive designation of a subject in the first moving image and control the imaging apparatus (an imaging system) to continuously image at least the designated subject.

The processor 100 can display the acquired moving image (the first moving image) on the display 140. The moving image may include a vocalization, and the processor 100 can output the vocalization from the speaker 165.

### [Specifying of First Subject]

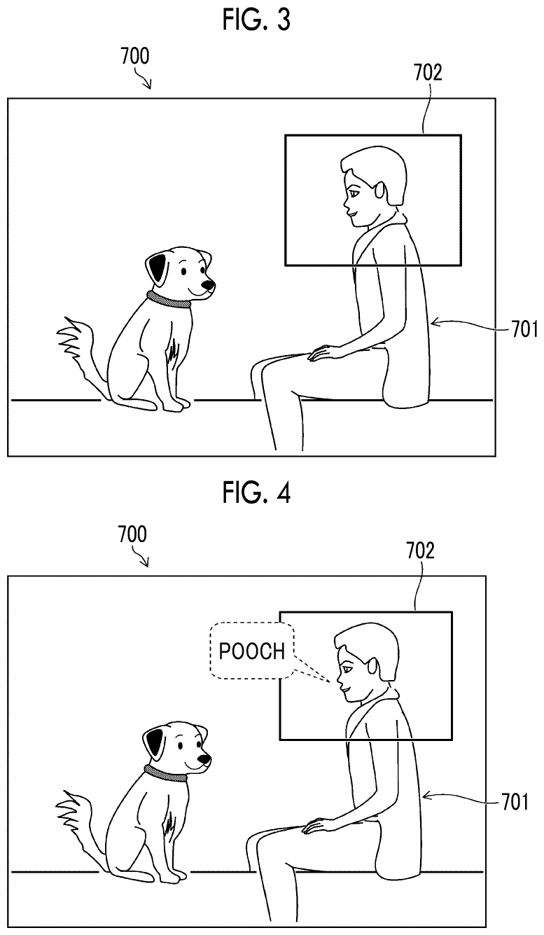

The processor 100 specifies (detects) the first subject in the frames of the acquired moving image (step S110). For example, the first subject is a main subject. The first subject may be a person, an animal, or an inanimate object, and the number of first subjects may be one or more. That is, the first subject is not limited in type or number. FIG. 3 illustrates a state where a person 701 who is the first subject (the main subject) is specified in a frame 700 of the moving image. The processor 100 can determine “what kind of subject is to be specified as the first subject” in accordance with a reference (for example, a person takes priority, a child takes priority, or a registered person takes priority) determined in advance, and may receive designation of the first subject from the user. In a case where a plurality of first subjects are present, the first subjects may be arranged in order of priority (for example, in a case where a plurality of children are detected, a child of the user comes first in order of priority).

The processor 100 can specify the first subject through feature value detection, pattern matching with a designated image, or the like, and may specify the first subject using a detector or a classifier constructed based on a machine learning algorithm. The machine learning algorithm is not particularly limited and can use, for example, a neural network such as a convolutional neural network (CNN). The processor 100 may perform the processing of specifying the first subject for all frames of the moving image, or may intermittently process a part of the frames at predetermined intervals.

In a case where the first subject is detected, the processor 100 may output a display indicating the detected first subject (for example, a symbol or a frame indicating the first subject; a frame 702 in the example of FIG. 3) on the moving image displayed on the display 140. Accordingly, the user can perceive whether or not the first subject is appropriately detected.

### [Detection of First Factor]

The processor 100 determines whether or not the first factor caused by the action of the first subject is detected in the first moving image (step S120). The processor 100 can use the first factor as a “motive” or “trigger” for starting the image processing (described later). For example, the processor 100 can detect one or more of a determined action of the first subject, information related to a direction of the first subject, and utterance of a determined vocalization of the first subject as the “first factor”. The “determined action” is, for example, moving (walking, running, or the like), directing a face or a body or a visual line or the like in a different direction, looking back, stretching out a hand, or pointing with a finger. The “direction of the first subject” is, for example, a direction of the face, a direction of the visual line, or a direction of a hand or a foot. The “determined vocalization” is, for example, calling a name or a nickname of a person, a pet, or the like, or uttering a specific keyword. However, the present invention is not limited to these examples. In a case where the first factor is detected, the processor 100 may provide notification indicating that the first factor is detected to the user (the same applies to a second factor (described later)). For example, the processor 100 can provide the notification by displaying a text, a figure, a symbol, or the like on the display 140 and/or outputting a vocalization from the speaker 165.

In the image processing device 10, it is preferable to record an event to be detected as the first factor in the recording device 160. The image processing device 10 may detect the first factor with reference to the external recording device or database in which the event is recorded. The processor 100 preferably has a vocalization recognition function for detecting the utterance of the vocalization as the first factor.

FIG. 4 is a diagram illustrating a state where the first factor is detected. The example of FIG. 4 shows a state where the person 701 who is the first subject utters a vocalization of “pooch”, and this utterance of the vocalization is detected as the above “first factor”. The speech bubble of a dotted line in FIG. 4 indicates that a word in the speech bubble is uttered as the vocalization (the same applies to the subsequent drawings).

### [Specifying of Region Including Second Subject]

The processor 100 detects the second subject (specifies a region including the second subject) in the first moving image based on the first factor (step S130). For example, the second subject is the sub-subject and is not limited in type or number, as described above for the first subject. The “region including the second subject” may not include the whole second subject and may include at least a part (for example, a face part of a person or an animal) (the same applies to the first subject). The processor 100 can detect the second subject after detecting the first factor and may also detect the second subject before detecting the first factor.

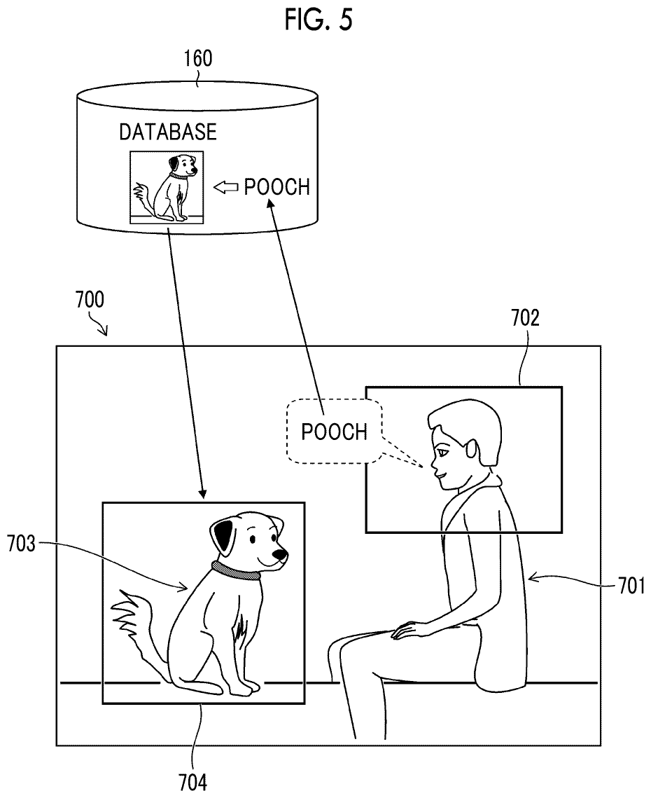

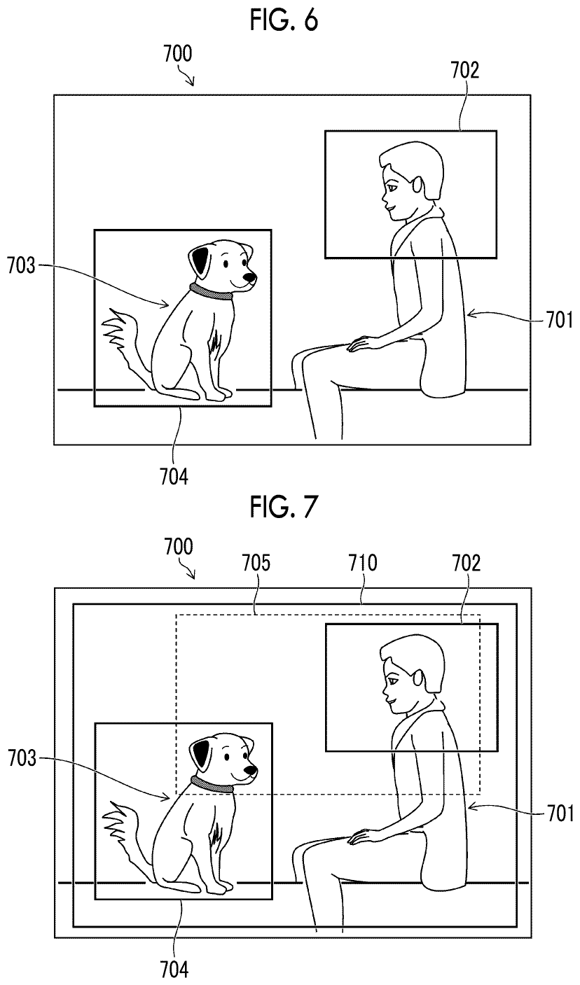

FIG. 5 is a diagram illustrating a state where the second subject is detected with reference to a database. In this database, for example, a word “pooch” that is the first factor, and a “dog” that is the second subject corresponding to the word are recorded in association with each other. The processor 100 detects a dog 703 (the second subject or the sub-subject) that is the second subject from the frame of the moving image with reference to the database using the first factor as a key. While a case where the database is recorded in the recording device 160 is described in FIG. 5, the database may be recorded in other recording devices accessible through the input/output interface 150. FIG. 6 illustrates a state where a region 704 including the dog 703 that is the second subject is specified. As described above for the first subject, a display indicating the detected second subject (in the example of FIG. 6, a frame display on the region 704) may be output on the moving image.

### [Image Processing]

The processor 100 starts the image processing (step S140). In this image processing, the processor 100 performs the image processing (may be at least one of the trimming or image quality adjustment) on at least the region including the second subject. The processor 100 can generate a moving image (the second moving image to the fifth moving image) different from the original moving image (the first moving image) through the image processing, and can display the generated moving image on the display 140 or record the generated moving image in the recording device 160.

### [Trimming of Moving Image]

### [Trimming of Region Including First Subject and Second Subject]

FIG. 7 is a diagram illustrating an example of the trimming (an aspect of the image processing). FIG. 7 illustrates an example in which a range (a region 710) including the person 701 (the first subject) and the dog 703 (the second subject) is trimmed. The processor 100 may display a moving image (an aspect of the second moving image) corresponding to the region 710 on the display 140. The region 710 may be extracted as a still image and displayed on the display 140, or may be recorded in the recording device 160. Through the trimming, a moving image in which “where interest or attention or the action of the person 701 (the first subject) is directed”, specifically the person 701 speaking to the dog 703, can be easily perceived can be generated.

The “region including the first subject and the second subject” may not include the whole first subject and the whole second subject, and may include at least a part of each of the first subject and the second subject (for example, the “part” may be a face part of a person or an animal). For example, the processor 100 may trim a region 705 (a region including a part of the person 701 and a part of the dog 703) in FIG. 7.

The processor 100 may change the range to be trimmed in accordance with passage of time or a change in circumstances (the action or the like of the subject). For example, a change such as “impressing the motion picture viewer with where the subject is by showing the background in an enlarged manner with respect to the person 701 (the first subject) and the dog 703 (the second subject) immediately after starting the trimming, and then, after an elapse of a determined time, showing the facial expression of the subject as large as possible by narrowing the trimming range, so that unnecessary objects are not included” can be made.

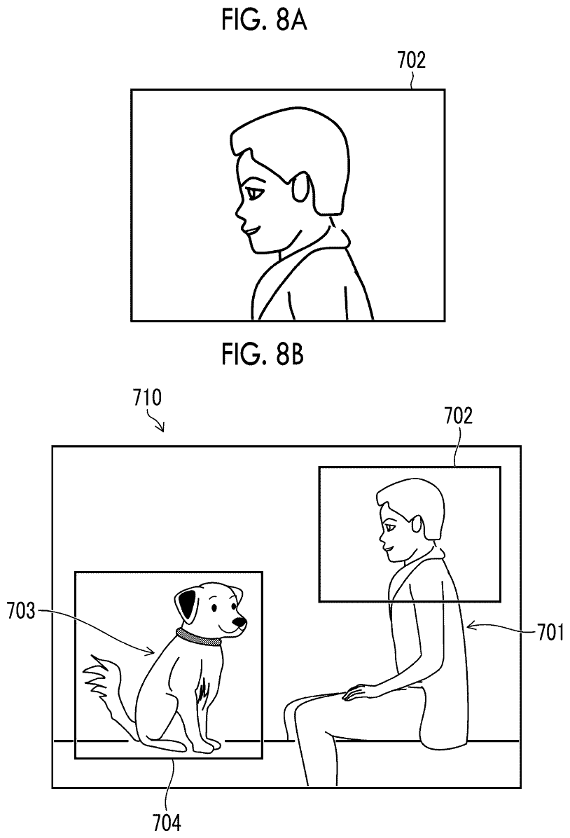

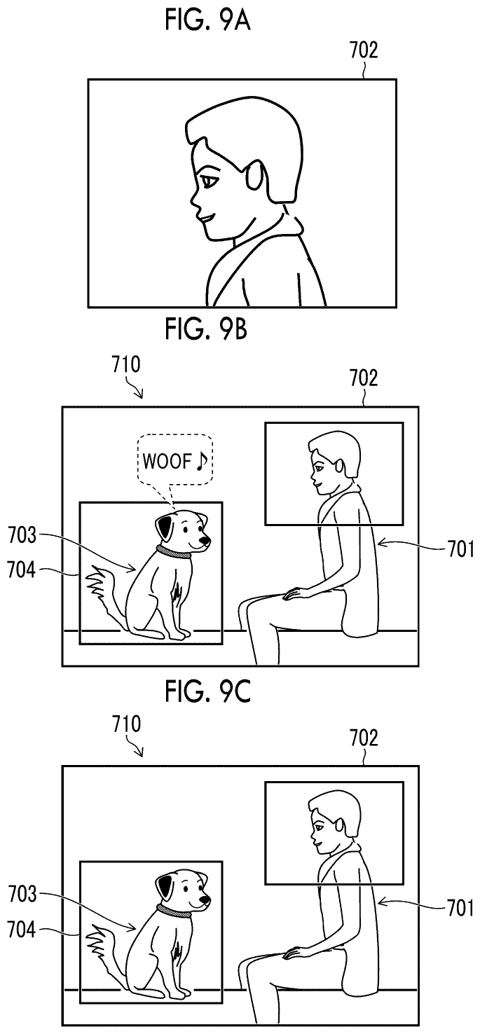

Specifically, for example, in a case where the person 701 who is the first subject (the main subject) and the dog 703 that is the second subject (the sub-subject) are looking at each other, the trimming range can be narrowed after the trimming in FIG. 7 so that the person 701 can be shown in an enlarged manner as illustrated in FIG. 8A and FIG. 9A. Accordingly, the moving image viewer can clearly perceive the facial expression of the person 701. The processor 100 can monitor a motion of the dog 703 (the second subject) (for example, continuously detect, extract, and recognize the action of the subject) in the first moving image as illustrated in FIG. 8B in parallel with the trimming.

In a case where any action of the dog 703 (the second subject) is detected in a circumstance where such monitoring is performed, the processor 100, for example, as illustrated in FIG. 9B, after detecting a sudden bark of the dog 703, can trim the range (the region 710) including the person 701 and the dog 703 again as illustrated in FIG. 7 and FIG. 9C. Accordingly, a moving image (an aspect of the second moving image) in which a characteristic action of the dog 703 (the second subject) is understood can be created.

### [Generation and Recording of Moving Image Through Trimming]

The processor 100 can generate a moving image different from the original moving image (the first moving image) through the trimming (an example of the image processing). Specifically, the processor 100 can generate the third moving image by trimming a range including the first subject from the first moving image, and can generate the fourth moving image (an aspect of the second moving image) by trimming a range including the second subject from the first moving image.

### [Association Between Third Moving Image and Fourth Moving Image]

The processor 100 can associate the third moving image and the fourth moving image with each other. Examples of an aspect of the “association” include making file names of the moving images common in part, storing the moving images in the same folder, recording a recording location or a file name of one moving image file in a header part or the like of another moving image file, and recording the third moving image and the fourth moving image in the database with corresponding file names. However, the present invention is not limited to these examples. The processor 100 can display the third moving image and/or the fourth moving image on the display 140 or record the third moving image and/or the fourth moving image in the recording device 160. The processor 100 may output the third moving image and/or the fourth moving image to an external display device or recording device through the input/output interface 150. The processor 100 can output (display or record) the moving image related to the designated moving image or output a list of associated moving images using a result of such association. The user can easily perceive relevance of the moving image from such association, and can use the relevance in searching for or viewing the moving image.

### [Generation of Fifth Moving Image]

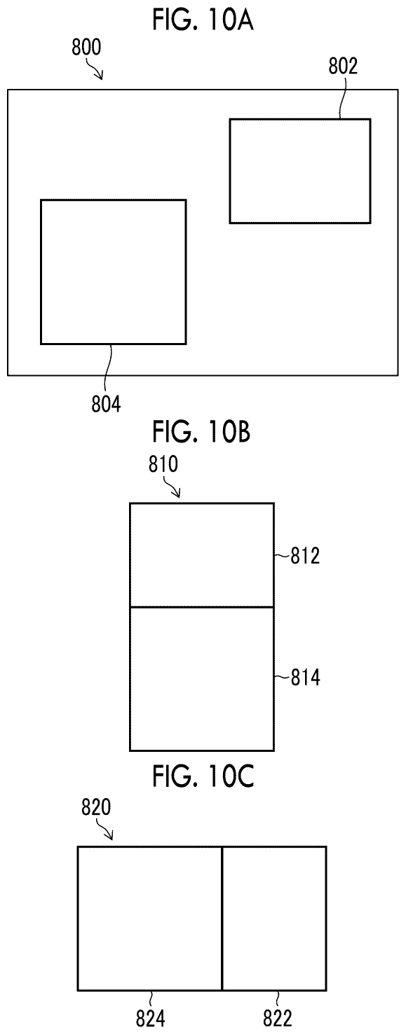

The processor 100 can generate the fifth moving image (the fifth moving image is also an aspect of the second moving image) that is one moving image, based on the third moving image and the fourth moving image. The processor 100 can display the fifth moving image on the display 140. FIGS. 10A to 10C are diagrams illustrating an example of disposition of regions in a frame of the fifth moving image. In FIG. 10A, a region 802 that is a part corresponding to the third moving image, and a region 804 that is a part corresponding to the fourth moving image are disposed in the same manner as the original first moving image in a fifth moving image 800. Similarly, in FIG. 10B, a region 812 that is a part corresponding to the third moving image, and a region 814 that is a part corresponding to the fourth moving image are disposed above and below each other in a fifth moving image 810. In FIG. 10C, a region 822 that is a part corresponding to the third moving image, and a region 824 that is a part corresponding to the fourth moving image are disposed on the left and right of each other in a fifth moving image 820. The fourth moving image may be displayed in a partial region of the third moving image, or the third moving image may be displayed in a partial region of the fourth moving image (so-called picture-in-picture). In the aspects of the fifth moving image, the processor 100 can display the third moving image and the fourth moving image in conjunction with each other (display frames of the same timing at the same time). In generating the fifth moving image, the processor 100 may further perform the trimming or the image quality adjustment on the part corresponding to the third moving image and the part corresponding to the fourth moving image. The processor 100 can record the generated fifth moving image in the recording device 160. The processor 100 may output the fifth moving image to the external display device or recording device through the input/output interface 150.

### [Image Quality Adjustment]

In the first embodiment, the image quality adjustment (an aspect of the image processing) may be performed instead of or in addition to the above trimming. That is, the processor 100 can perform at least one of the trimming or the image quality adjustment as the image processing. Examples of the image quality adjustment include at least one of resolution, noise, color tone, brightness, contrast, contours, or a special effect (for example, addition of a text, a symbol, or a figure). However, the present invention is not limited to these examples. The processor 100 can perform the image quality adjustment on at least the region including the second subject, and can also perform the image quality adjustment on the region including the first subject. The processor 100 can determine what kind of image quality adjustment is to be performed in accordance with designation of the user or automatically regardless of designation of the user.

### [Period for Performing Image Processing]

The processor 100, after detecting the first factor, performs the image processing for a period from detection of the first factor to satisfaction of a predetermined condition (a finish condition of the image processing) (until step S150 results in YES). In a case where a determined time elapses from the detection of the first factor, and/or the second factor caused by the action of the first subject or the second subject is detected, the processor 100 can determine that the “predetermined condition” is satisfied. Specifically, for example, the processor 100 can determine that the “predetermined condition is satisfied” by regarding a bark of the dog in the state illustrated in FIG. 9B as the “second factor caused by the action of the second subject”.

### [Generation of Still Image]

The processor 100 can extract (generate) a frame of the moving image (the first moving image to the fifth moving image) as a still image. For example, the processor 100 can generate the still image at a timing at which the first factor is detected, a timing at which the second factor is detected, or a timing at which the trimming range or content and/or a degree of the image quality adjustment changes. By generating the still image at such a timing, a still image (a still image group) having a narrative can be obtained. The processor 100 may generate the still image at determined time intervals or may generate the still image in accordance with an instruction of the user. The processor 100 may display the generated still image on the display 140 or other display devices, or may record the generated still image in the recording device 160.

In a case where step S150 results in YES, the processor 100 finishes the image processing and determines whether or not to finish editing of the moving image (step S170). For example, in a case where the processing is finished for all frames of the moving image, or the user provides an instruction to finish the editing, the editing is finished (step S170 results in YES).

As described above, according to the image processing device 10 according to the first embodiment, a moving image in which an intention of an imaging person or an editor or a relationship between subjects is easily understood can be generated. In addition, a moving image having a narrative in which a target of the action of the first subject is understood can be generated. Furthermore, since the image processing device 10 performs such image processing, a load of editing the moving image for the user can be reduced.

### Second Embodiment

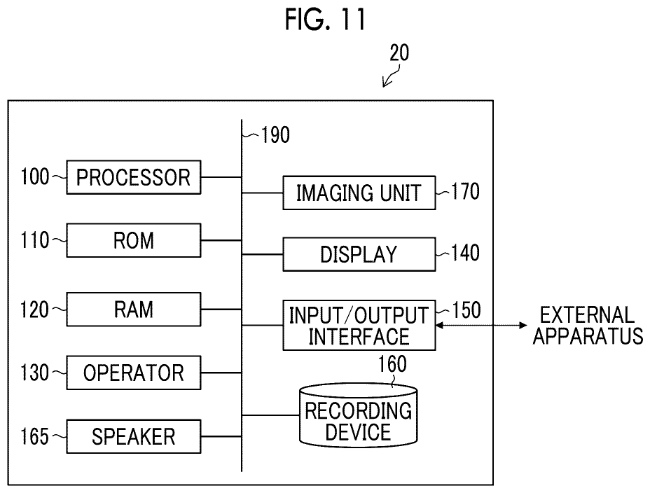

Next, a second embodiment of the present invention will be described. FIG. 11 is a diagram illustrating a configuration of an imaging apparatus according to the second embodiment. The same configurations as the first embodiment will be designated by the same reference numerals and will not be described in detail.

As illustrated in FIG. 11, an imaging apparatus 20 (the imaging apparatus) according to the second embodiment comprises an imaging unit 170 (the imaging system). The imaging unit 170 captures the moving image (the first moving image) under control of a processor 102 (the processor).

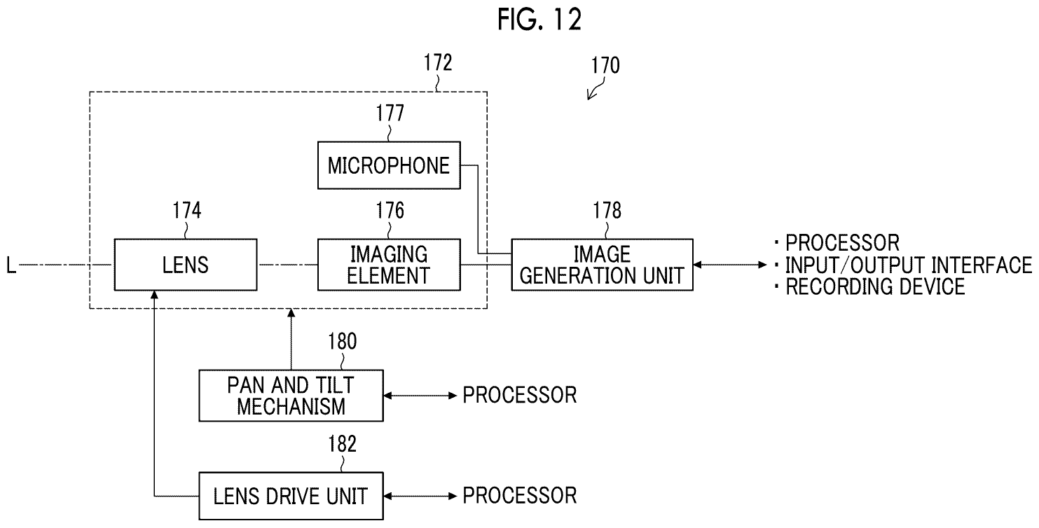

FIG. 12 is a diagram illustrating a configuration of the imaging unit 170. As illustrated in FIG. 12, the imaging unit 170 comprises an optical system 172 including a lens 174 having an optical axis L, an imaging clement 176, and a microphone 177, and a pan and tilt mechanism 180 can drive the optical system 172 in an azimuthal angle direction and/or an elevation direction. The lens 174 is composed of a plurality of lenses including a zoom lens and a focus lens, and a lens drive unit 182 drives the plurality of lenses to adjust zoom and focus. An optical image of the subject is formed on a light-receiving surface of the imaging element 176 by the lens 174, and an image generation unit 178 generates the moving image or the still image by performing predetermined processing (D/A conversion, synchronization, or the like) on a signal output from the imaging element 176 in accordance with the optical image.

The optical system 172 may be an omnidirectional imaging system or a hemispherical imaging system capable of imaging all directions about the optical axis L (360 degrees; a range corresponding to a solid angle of 2π (sr)), or may be a full-spherical imaging system (a celestial-spherical imaging system) capable of imaging all directions about an azimuthal angle and an elevation (a range corresponding to a solid angle of 4π (sr)) via a plurality of lenses. In a case where the optical system 172 is a full-spherical imaging system or a celestial-spherical imaging system, a single image for the whole sphere or the whole celestial sphere may be acquired by compositing image groups obtained by the plurality of lenses.

The processor 102 can receive designation of the subject in the first moving image and control the imaging unit 170 (the imaging system) to continuously image at least the designated subject.

In the imaging apparatus 20 according to the second embodiment, the same image processing as the above first embodiment (the image processing on at least the region including the second subject) can be performed on the moving image captured by the imaging unit 170. The imaging apparatus 20 can be applied to not only general capturing and editing of the moving image but also a surveillance camera system. In this case, for example, the image processing can be performed by regarding one of a security guard or a suspicious person as the first subject and regarding the other as the second subject.

While the embodiments of the present invention are described above, the present invention is not limited to the above aspects and can be modified in various manners.

### EXPLANATION OF REFERENCES

10: image processing device

20: imaging apparatus

100: processor

102: processor

130: operator

140: display

150: input/output interface

160: recording device

165: speaker

170: imaging unit

172: optical system

174: lens

176: imaging element

177: microphone

178: image generation unit

180: pan and tilt mechanism

182: lens drive unit

700: frame

701: person

702: frame

703: dog

704: region

705: region

710: region

800: fifth moving image

802: region

804: region

810: fifth moving image

812: region

814: region

820: fifth moving image

822: region

824: region

What is claimed is:

1. An image processing device comprising:
a processor,
wherein the processor is configured to:
acquire a first moving image;
specify a first subject included in the first moving image;
detect a first factor caused by an action of the first subject in the first moving image;
specify a region including a second subject in the first moving image based on the first factor; and
perform image processing on at least the region including the second subject.

2. The image processing device according to claim 1,
wherein the processor is configured to generate a second moving image through the image processing.

3. The image processing device according to claim 1,
wherein the processor is configured to detect the second subject after detecting the first factor.

4. The image processing device according to claim 1,
wherein the processor is configured to detect one or more of a determined action of the first subject, information related to a direction of the first subject, and utterance of a determined vocalization of the first subject as the first factor.

5. The image processing device according to claim 1,
wherein the processor is configured to perform at least one of trimming or image quality adjustment as the image processing.

6. The image processing device according to claim 1,
wherein the processor is configured to trim at least a range including the second subject from the first moving image.

7. The image processing device according to claim 6,
wherein the processor is configured to trim a range including the first subject and the second subject from the first moving image.

8. The image processing device according to claim 1,
wherein the processor is configured to:
generate a third moving image by trimming a range including the first subject from the first moving image;
generate a fourth moving image by trimming a range including the second subject from the first moving image; and
associate the third moving image and the fourth moving image with each other.

9. The image processing device according to claim 8,
wherein the processor is configured to generate a fifth moving image that is one moving image, based on the third moving image and the fourth moving image.

10. The image processing device according to claim 1,
wherein the processor is configured to adjust the first moving image for at least one of resolution, noise, color tone, brightness, contrast, contours, or a special effect.

11. The image processing device according to claim 1,
wherein the processor is configured to perform the image processing for a period from detection of the first factor to satisfaction of a predetermined condition.

12. The image processing device according to claim 11,
wherein the processor is configured to, in a case where a determined time elapses from the detection of the first factor, and/or a second factor caused by an action of the first subject or the second subject is detected, determine that the predetermined condition is satisfied.

13. The image processing device according to claim 2,
wherein the processor is configured to extract a frame of the second moving image as a still image.

14. An imaging apparatus comprising:
the image processing device according to claim 1; and
an imaging system that captures the first moving image,
wherein the processor is configured to perform the image processing on the first moving image captured by the imaging system.

15. The imaging apparatus according to claim 14,
wherein the processor is configured to receive designation of a subject in the first moving image and control the imaging system to continuously image at least the designated subject.

16. The imaging apparatus according to claim 14,
wherein the imaging system is an omnidirectional imaging system.

17. An operation method of an image processing device including a processor, the operation method comprising:
via the processor,
acquiring a first moving image;
specifying a first subject included in the first moving image;
detecting a first factor caused by an action of the first subject in the first moving image;
specifying a region including a second subject in the first moving image based on the first factor; and
performing image processing on at least the region including the second subject.
